(19) United States
(12) Patent Application Publication
(10) Pub. No.: US 2019/0301298 A1
(43) Pub. Date: Oct. 3, 2019

(54) LINER STRUCTURE FROM METALLIC MATERIAL, METHOD FOR MANUFACTURING A LINER STRUCTURE AND COMPONENT WITH A LINER STRUCTURE

(71) Applicant: Rolls-Royce Deutschland Ltd & Co KG, Blankenfelde-Mahlow (DE)

(72) Inventors: Matthias DUDECK, Rangsdorf (DE); Bjoern ULRICHSOHN, Dresden (DE); Karl SCHREIBER, Am Mellensee (DE)

(21) Appl. No.: 16/366,603

(22) Filed: Mar. 27, 2019

(30) Foreign Application Priority Data
Mar. 28, 2018 (DE) 10 2018 107 433.6

(51) Int. Cl. F01D 11/12; B22F 3/11

(52) U.S. Cl. CPC F01D 11/122; B22F 3/1137; B22F 3/1125; F05D 2240/55; B22F 2304/10; F05D 2300/701; F05D 2300/611; F05D 2230/40; F05D 2230/90; F05D 2300/612

(57) ABSTRACT

An abradable coating structure with at least partially closed cells made of a metallic material with a mean cell wall porosity between 7 and 50%, in particular between 20 and 40%, a mean cell wall thickness between 50 and 200 μm, in particular between 80 and 150 μm, a cell size with a mean free diameter between 200 μm and 15 mm, in particular 2 mm or in particular between 8 and 12 mm and a mean carbon concentration in the material of between 0 and 5% by weight, in particular between 0.05 and 2% by weight. The invention also relates to a component with a polyhedral cell structure and to a method for manufacturing the polyhedral cell structure.

This application claims priority to German Patent Application DE102018107433.6 filed Mar. 28, 2018, the entirety of which is incorporated by reference herein.

The present invention relates to an abradable coating structure having the features of Claim 1, to a method for manufacturing an abradable coating structure having the features of Claim 4 and to a component having an abradable coating structure having the features of Claim 12.

In turbomachines (e.g. aircraft engines), use is made of components which fail selectively under mechanical stress, e.g. in labyrinth seals or liners; these components are referred to here as abradable coating structures. Thus, in labyrinth seal systems, for example, honeycomb structures consisting of ductile material (e.g. Hastelloy X) and sealing lips (without a coating, e.g. made of TBT406) are used. In the case of abrasion, i.e. when there is mechanical contact with the honeycomb structure, heat is released owing to the friction, as a result of which the ribs of the labyrinth seal may break. Other seals are known from DE 102 21 114 C1 or DE 10 2009 016 803 A1. Cellular structures and methods for the manufacture thereof are known from U.S. Pat. No. 6,916,529 B2, DE 39 02 032 C2 and EP 2 418 354 A1, for example.

The object is to selectively influence the behavior of such components containing cavities (e.g. cells) during mechanical contact events so that less heat is released.

This object is achieved by an abradable coating structure having the features of Claim 1.

The abradable coating structure made of a metallic material has cells, wherein the cells are at least partially closed. This means that some cells in the abrading coating structure are open and some cells are themselves closed. The cells form a polyhedral cell structure, for example, as a special form of a material structured in a cellular way. In this case, the cells, i.e. the cavities, are formed by polygons, generally irregular polygons. In principle, other cell structures can also be used for the abradable coating structures.

The cell wall porosity, i.e. the porosity of the cell walls, is between 7 and 50%, in particular between 20 and 40%, on average.

The mean cell wall thickness is between 50 and 200 μm, in particular between 80 and 150 μm.

The cell size has a mean free diameter between 200 μm and 15 mm, in particular between 1 and 5 mm, in particular 2 mm, or between 8 and 12 mm. The free diameter is the longest distance within a cell cross section of the abradable coating structure.

The metallic material has a mean carbon concentration between 0 and 5% by weight, in particular between 0.05 and 2% by weight.

With this combination of properties, walls of the cells are more easily susceptible to brittle fracture, in particular, i.e. the material used is less ductile. This reduces the generation of heat in the case of abrasion, for example.

In one embodiment, the cells have an average of 10 to 30 side faces, in particular 15 to 25 side faces. In the case of a polyhedral cell structure, the side faces are formed by polygons.

In one embodiment, MCrAlY or an alloy containing aluminum, chromium and/or hafnium is used as the metallic material.

The object is also achieved by a method having the features of Claim 4.

In this context, a powder-metallurgical method, in particular a molding method is used, in which a metal powder and a template made of plastic are used as starting materials.

In one embodiment, the template comprises plastic particles, in particular particles of polystyrene, wherein the mean diameter of the plastic particles is between 0.02 and 0.3 mm, and optionally comprises a hydrocarbon, in particular pentane, as a blowing agent. In addition and/or as an alternative, the particles of the metal powder can have a diameter d₅₀ between 5 and 45 μm, in particular 15 μm.

In a first step, the plastic particles are preheated to a temperature above the corresponding glass transition temperature, in particular between 80 and 125° C., as a result of which pre-foaming is initiated by the escape of the blowing agent.

This is followed by coating of the plastic particles with a metal (e.g. in the form of metal powder) and a binder, in particular in a fluidized bed method. This may be followed by sintering.

Also, in a sintering process the sintering temperature may lie between 1050° C. and 1350° C., in particular between 1135° C. and 1250° C.

The coated plastic particles are then transferred, e.g. blown, into a cavity while heat is supplied, wherein the plastic particles expand further and join together (e.g. by welding) and, after cooling, cell walls of the abradable coating structure remain.

Organic substances are removed from the abradable coating structure by means of a thermal treatment (e.g. pyrolysis).

The object is also achieved by a component in a fluid machine having the features of Claim 11.

Illustrative embodiments are described in connection with figures, of which

FIG. 1 shows a sectioned side view of a geared fan engine;

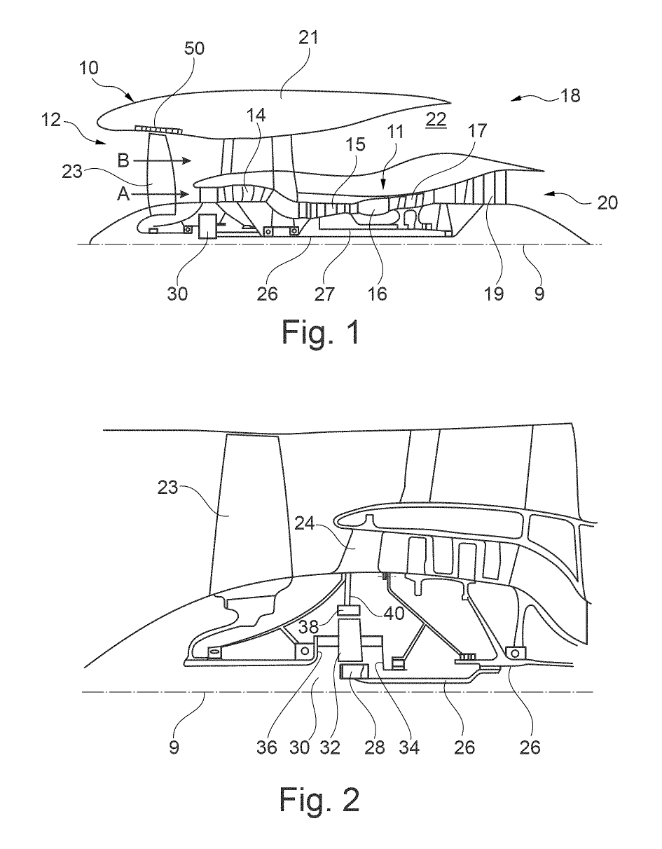

FIG. 2 shows an enlarged view of a sectioned side view of the front part of the engine shown in FIG. 1;

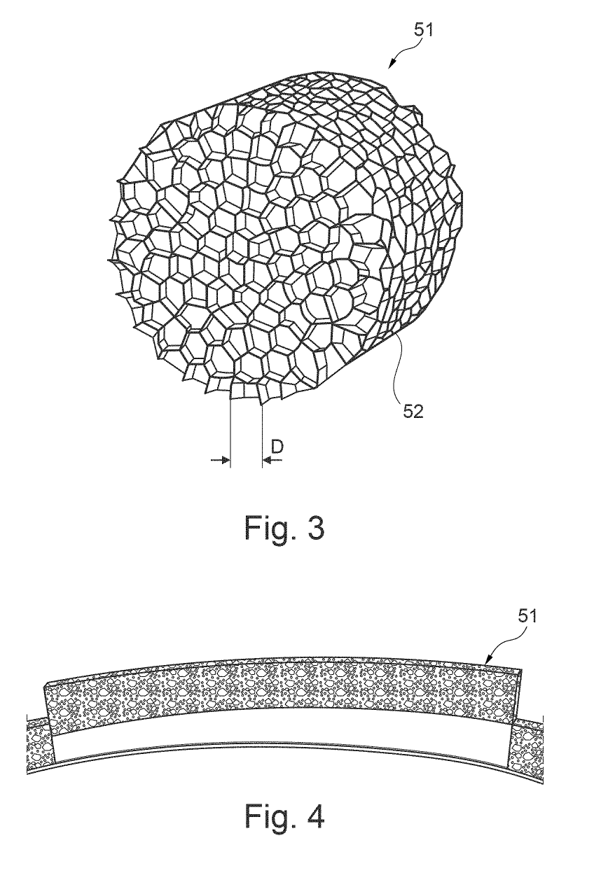

FIG. 3 shows a perspective illustration of an abradable coating structure known per se;

FIG. 4 shows a side view of a segment of a polyhedral cell structure as an embodiment of an abradable coating structure;

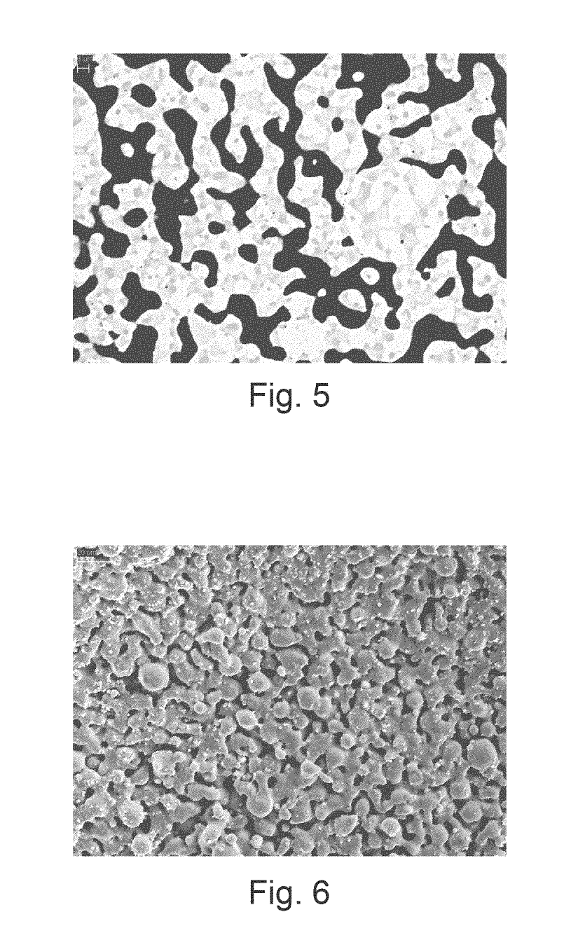

FIG. 5 shows an enlarged section through a cell wall of an abradable coating structure;

FIG. 6 shows an enlarged plan view of a cell wall of a polyhedral cell structure (material: MCrAlY) as an embodiment of an abradable coating structure;

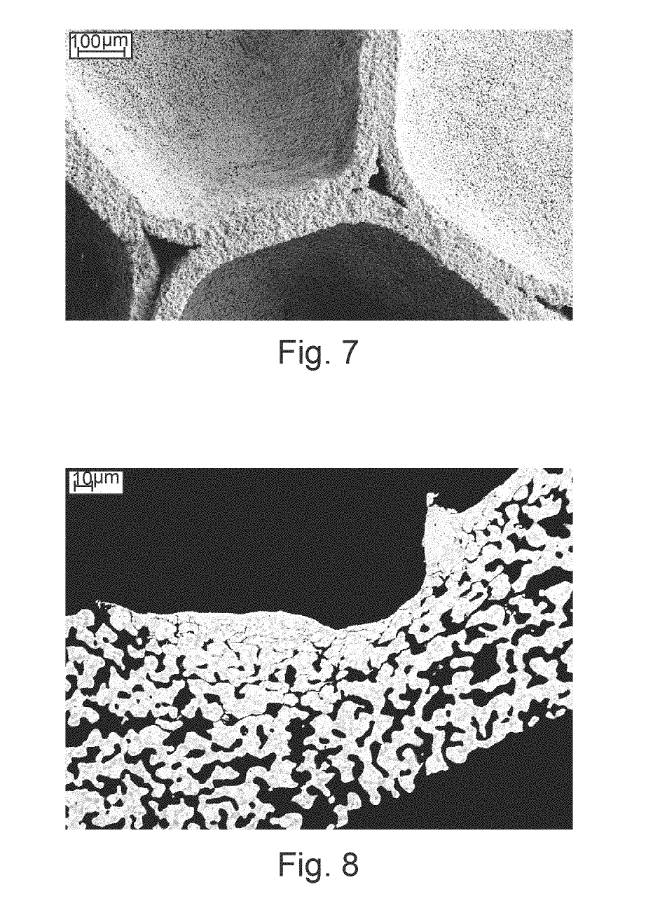

FIG. 7 shows an enlarged section through a cell of a cell structure (material: MCrAlY) in an abradable coating structure;

FIG. 8 shows an enlarged section through a cell wall (material: MCrAlY);

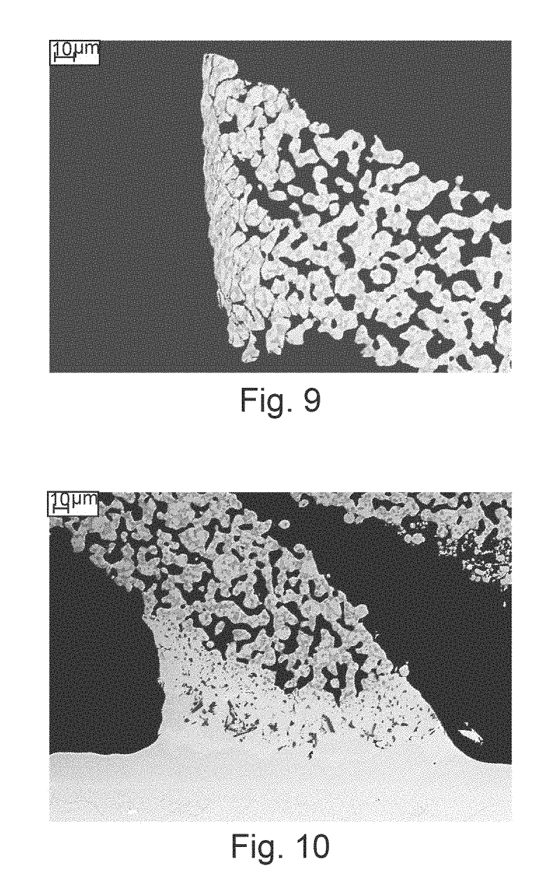

FIG. 9 shows another enlarged section through a cell wall (material: MCrAlY);

FIG. 10 shows an enlarged section through a joint.

One possible use of embodiments of the abradable coating structure is described below with reference to a geared fan engine.

In this context, FIG. 1 describes an aircraft engine 10 having a principal rotational axis 9. The aircraft engine 10 has an air intake 12 and a fan 23, which produces two airflows: an airflow A through a core engine 11 and a bypass airflow B.

When viewed in the axial direction of flow, the core engine 11 comprises a low pressure compressor 14, a high pressure compressor 15, a burner device 16, a high pressure turbine 17, a low pressure turbine 19 and a core engine outlet nozzle 20. A nacelle 21 surrounds the aircraft engine 10 and defines the bypass duct 22 (also referred to as a secondary flow duct) and a bypass duct outlet nozzle 18. The bypass airflow B flows through the bypass duct 22. The fan 23 is driven by the low pressure turbine 19 via the shaft 26 and a planetary gearbox 30. Opposite the fan 23 on the inside of the nacelle 21 is a liner 50, which has, inter alia, an embodiment of a component, described below, having an abradable coating structure 51 (see FIG. 3).

In operation, the airflow A in the core engine 11 is accelerated and compressed by the low pressure compressor 14, wherein it is guided into the high pressure compressor 15, in which further compression takes place. The compressed air emerging from the high pressure compressor 15 is guided into the burner device 16, in which it is mixed with fuel and burnt.

The hot combustion gases formed are passed through the high pressure turbine 17 and the low pressure turbine 19, which are driven by the combustion gases. The MIM components can be used in the low pressure compressor 14, the high pressure compressor 15, the high pressure turbine 17 and/or the low pressure turbine 19, for example. Here, the highest temperatures occur at the outlet of the burner device 16 and at the inlet of the high pressure turbine 17.

The combustion gases emerge through the core outlet nozzle 20 and provide a proportion of the total thrust. The high pressure turbine 18 drives the high pressure compressor 15 via an appropriate interconnecting shaft 27. The fan 23 generally provides the greatest proportion of the propulsive thrust. Here, the planetary gearbox 30 is designed as a reduction gearbox in order to reduce the rotational speed of the fan 23 relative to the driving turbine.

An exemplary arrangement for a geared fan arrangement of an aircraft gearbox is illustrated in FIG. 2.

The low pressure turbine 19 (see FIG. 1) drives the shaft 26, which is coupled to a sun gear 28 of the planetary gearbox 30. Radially outwardly of the sun gear 28 and in mesh there is a multiplicity of planet gears 32 coupled together by a planet carrier 34. The planet carrier 34 forces the planet gears 32 to precess around the sun gear 28 in synchronicity, whilst enabling each planet gear 32 to rotate about its own axis. The planet carrier 34 is coupled to the fan 23 by links 36 in order to bring about the rotation of said fan about the rotational axis 9. Connected radially outwardly of the planet gears 32 and in mesh therewith there is a ring gear or annulus 38, which is connected, via links 40, to a stationary supporting structure 24. This design represents an epicyclic planetary gearbox 30.

It should be noted that the expressions “low pressure turbine” and “low pressure compressor”, as used here, can be understood to mean that they signify the lowest-pressure turbine stages and the lowest-pressure compressor stages (i.e. without the fan 23) and/or the turbine and compressor stages which are connected together by the interconnecting shaft 26 with the lowest rotational speed in the engine 10 (i.e. without the gearbox output shaft that drives the fan 23). Alternatively, a “low pressure turbine” and a “low pressure compressor” to which reference is made here can also be understood to mean an “intermediate pressure turbine” and an “intermediate pressure compressor”. When such alternative nomenclature is used, the fan 23 can be referred to as a first or a lowest compressor stage.

The planetary gearbox 30 which is illustrated by way of example in FIG. 2 is an epicyclic planetary gearbox since the planet carrier 34 is connected rotatably, i.e. in particular drivably, to the fan 23 by a shaft. In contrast, the hollow shaft 38 is of fixed design.

However, any other suitable type of planetary gearbox 30 can also be used.

As another example, the planetary gearbox 30 may have a star arrangement, in which the planet carrier 34 is held fixed and the annulus 38 can rotate. In such an arrangement, the fan 23 is driven by the annulus 38. As another alternative example, the gearbox 30 may be a differential, in which both the annulus 38 and the planet carrier 34 can rotate.

It is clear that the arrangement shown in FIG. 2 is by way of example only and that various alternatives are also within the scope of protection of the present disclosure. Purely by way of example, any suitable arrangement may be used to arrange the planetary gearbox 30 in the engine 10 and/or to connect the planetary gearbox 30 to the engine 10. As another example, the links (such as the links 36, 40 in the embodiment shown in FIG. 2) between the planetary gearbox 30 and other parts of the engine 10 (such as the core engine shaft 26, the output shaft and the stationary supporting structure 24) may have any desired degree of stiffness or flexibility.

As another example, any suitable arrangement of the bearings between the rotating and stationary parts of the engine 10 (e.g. between the input and output shafts of the planetary gearbox 30 and the fixed structures, e.g. the gearbox casing) may be used and there is no restriction to the exemplary arrangement in FIG. 2. If the planetary gearbox 30 has a star arrangement, for example, a person skilled in the art would understand that the arrangement of output and support links and bearing locations would typically be different to that shown in FIG. 2.

Accordingly, the present disclosure extends to an aircraft engine 10 having any desired arrangement of gearbox forms (e.g. star arrangement or epicyclic planetary arrangements), supporting structures, input and output shaft arrangement and bearing points.

Optionally, the planetary gearbox 30 may drive additional and/or alternative components (e.g. the intermediate pressure compressor and/or a booster compressor).

Other aircraft engines 10 to which the present disclosure may be applied may have alternative configurations. Such aircraft engines 10 may have a different number of compressors and/or turbines and/or a different number of interconnecting shafts, for example. As a further example, the engine 10 shown in FIG. 1 has a split-flow nozzle 20, meaning that the flow through the bypass duct 22 has its own nozzle that is separate from and arranged radially outside the core engine outlet nozzle 20. This should not be taken as restrictive, and any aspect of the present disclosure may also be applied to engines 10 in which the flow through the bypass duct 22 and the flow through the core engine 11 are mixed or combined (before or upstream) by a single nozzle. This is referred to as a mixed flow nozzle. One or both nozzles (irrespective of whether there is mixed or partial flow) may have a fixed or variable cross section. Whereas the example described here refers to a turbofan engine, the disclosure may be applied to any type of aircraft turbine, for example, including, for example, an engine 10 which has an open rotor (in which the fan stage 23 is not surrounded by a housing) or a turboprop engine.

The geometry of the aircraft engine 10 and of the components thereof is defined by a conventional axis system, which comprises an axial direction (which is aligned with the rotational axis 9), a radial direction (in the bottom-to-top direction in FIG. 1) and a circumferential direction (perpendicular in the view in FIG. 1). The axial, radial and circumferential directions are mutually perpendicular.

It was explained above that a liner 50 can have an abradable coating structure 51.

FIG. 3 shows a body from a polyhedral cell structure of an abradable coating structure in a perspective illustration. The sectioned surfaces show that the cross sections of the cells 52 often have 4 to 7 angles. On average, the cells are bounded by about 10 to 30 side faces.

In FIG. 3, a free diameter D for a cell 52 is illustrated by way of example. Here, this is the longest distance within the cross section of the cell 52. The mean free diameter can be obtained, for example, by forming a section through a polyhedral cell structure 51 (e.g. in FIG. 3) and then determining the longest diameter for all the cells 52. This is then averaged over the number of cells 52 in the cross section. The mean free diameter D can be between 200 μm and 15 mm.

The porosity of the walls of the cells 52 is between 7 and 50%. FIGS. 5 and 6 illustrate enlarged images of cell walls, which have a relatively high porosity. Here, FIG. 5 shows a sectional view and FIG. 6 shows a plan view.

The mean cell wall thickness of the cells 52 is between 50 and 200 μm (see FIG. 7, for example). In the example shown, the cell wall thickness is about 100 μm. The way in which these walls are produced is explained below.

The compaction capacity of the cell wall is illustrated in FIGS. 8 and 9. Clear instances of compaction, i.e. a local reduction in porosity, can be seen at the top edge of the cell structure in FIG. 8 and at the left-hand edge of the cell structure in FIG. 9. Improved micro-deformability is thus achieved.

FIG. 10 illustrates that the relatively high porosity (and the associated capillary action) in the cell wall also has the effect that a component with such a cell wall has good brazing characteristics.

The manufacture of one embodiment of this polyhedral cell structure as an embodiment of an abradable coating structure is described below.

The starting materials are a metal powder and a template for the formation of the cells.

The metal powder has a mean d₅₀ between 5 and 15 μm, i.e. the powder grains are relatively small. In this context, MCrAlY can be used as the metal powder, for example. In all cases, the metallic material has a carbon concentration of between 0 and 5% by weight. The higher the carbon concentration, the better the brittle fracture properties, but the lower is the oxidation resistance of the abradable coating structure 51.

In one embodiment, expandable polystyrene is used as the template, wherein the corresponding granules have a mean diameter of 0.2 to 3.0 mm. When polystyrene is the template body, pentane is included in dissolved form as a blowing agent, for example.

FIG. 4 illustrates a segment of an abradable coating structure 51, which can be used as a liner 50 in an aircraft engine or in combination with a labyrinth seal, for example.

The manufacturing process essentially has four process steps.

1. First of all, the expandable polystyrene particles are pre-foamed. The foam is formed when these particles are heated above the glass transition temperature of 75-100° C.

During this process, the dissolved gas (e.g. pentane) expands, causing the softened polymer to foam. In the process, the particle diameter increases by approximately three times. During pre-foaming, the particles are heated by means of steam or, less commonly, by means of hot air or hot water to temperatures between 80 and 125° C. This gives rise to spherical templates that can still be blown, which are then coated in the next step.

2. The individual cells 52 of the subsequent abradable coating structure 51 are produced by coating the expandable polystyrene particles with the application of a binder/metal powder suspension. For this slip coating process, there is a known fluidized bed method, in particular the bladed-rotor and continuously operating Procell method by Glatt, Weimar, which is described in DE 101 30 334 A1, for example.

In this method, the templates are held suspended by a fluidized bed, wherein the slip is simultaneously atomized and sprayed into the fluidized bed. Uniform coating of all the polystyrene particles is thereby achieved.

The airflow which the fluidized bed produces simultaneously dries the slip on the polystyrene particles. This leads to a solid metallic layer with good adhesion and prevents smearing of the slip in the plant and sticking of the templates to one another. By virtue of the simultaneously induced rotary motion, the product particles are rounded and compacted, considerably improving the coating quality of the green particles. During coating, significant parameters of the structure are selectively adjusted, in particular to the abovementioned values for the layer thickness and porosity of the layer.

The minimum layer thickness for a homogeneous layer on the template is about five times the particle diameter of the metal powder used. Thus, even thick layers of more than one millimeter can be achieved economically. To manufacture abradable coating structures, it is necessary to use suspensions which allow expansion.

3. The abradable coating structure 51 is produced using an automatic molding machine. In this machine, the pre-foamed material is blown into a cavity by compressed air injectors. These molds can comprise individual molds or mold cavities. By means of saturated steam, the expanded polystyrene particles are then raised above their softening temperature at temperatures of about 120° C. The pre-foamed polystyrene particles expand further owing to the effect of the heat, with the result that they fill the remaining space and weld together. After cooling, the cell structure is stabilized, and the molding, i.e. the polyhedral cell structure 51, is ejected. The method is based particularly on an adhesion process. For this to occur, the binder-containing surface of the dried metallic particles must be wetted. This reactivates the binder of the coated particles.

The polystyrene moldings with their metallic coating can also be re-foamed. In the case of very intense re-foaming, the individual particles are foamed to such an extent that the gaps between the cells are closed, and the polyhedral cell structure 51 is then formed.

4. By means of a subsequent heat treatment, the organic substances (binders, suspension agents, expanded polystyrene templates) are first of all removed by heating. Here, the binder removal temperatures are 450-650° C. Depending on the material, the binders are removed in an H₂, Ar—H₂ (95% Ar) or Ar atmosphere.

Sintering generally takes place under hydrogen at sintering temperatures between 1050° C. and 1350° C., in particular between 1250° C. and 1350° C.

The sintering temperatures are dependent in particular on the debindering system. The more carbon and/or oxygen remain in the brown blank during the binder removal, the higher the sintering temperature has to be chosen.

The particle size d₅₀ of the powder lies in the range of up to 45 μm, in particular at 15 μm.

For heat treating the polyhedral cell structures 51, use is made primarily of furnace technology. For smaller piece numbers, heat treatment is carried out in batch furnaces. In this context, debindering furnaces and sintering furnaces are used. This procedure is very flexible in terms of atmospheres and temperatures.

### LIST OF REFERENCE SIGNS

9 Rotational axis
10 Aircraft engine
11 Core engine
12 Air inlet
14 Compressor, low-pressure compressor
15 High-pressure compressor
16 Burner device
17 High-pressure turbine
18 Bypass duct outlet nozzle
19 Turbine, low pressure turbine
20 Core engine outlet nozzle
21 Nacelle
22 Bypass channel (secondary flow channel)
23 Fan
24 Stationary supporting structure
26 Core engine shaft
27 Interconnecting shaft
28 Sun gear
30 Planetary gearbox
32 Planet gear
34 Planet carrier for planet gears
36 Links
38 Annulus
40 Links
50 Abradable coating
51 Abradable coating structure
52 Cell of a polyhedral cell structure
A Airflow through core engine
B Bypass airflow
D Free diameter of a cell in a polyhedral cell structure

1. An abradable coating structure with at least partially closed cells made of a metallic material with a
mean cell wall porosity between 7 and 50%, in particular between 20 and 40%, a
mean cell wall thickness between 50 and 200 μm, in particular between 80 and 150 μm, a
cell size with a mean free diameter between 200 μm and 15 mm, in particular 2 mm or in particular between 8 and 12 mm and a
mean carbon concentration in the material of between 0 and 5% by weight, in particular between 0.05 and 2% by weight.

2. The abradable coating structure according to claim 1, characterized by cells, in particular in the form of a polyhedral cell structure, having an average of 10 to 30 side faces, in particular 15 to 25 side faces.

3. The abradable coating structure according to claim 1, wherein MCrAlY or an alloy containing aluminum, chromium and/or hafnium is used as the material.

4. A method for manufacturing an abradable coating structure, in particular according to claim 1, wherein a powder-metallurgical method, in particular a molding method is used, in which a metal powder and a template made of plastic are used as starting materials.

5. The method according to claim 4, wherein the template comprises plastic particles, in particular particles of polystyrene, wherein the mean diameter of the plastic particles is between 0.02 and 0.3 mm, and optionally comprises a hydrocarbon, in particular pentane, as a blowing agent.

6. The method according to claim 4, wherein the metal powder has a diameter d₅₀ between 5 and 15 μm.

7. The method according to claim 4, wherein the plastic particles are preheated to a temperature above the corresponding glass transition temperature, in particular between 80 and 125° C., as a result of which pre-foaming is initiated by the escape of the blowing agent.

8. The method according to claim 7, wherein, after pre-foaming, the plastic particles are coated with a metal and a binder, in particular in a fluidized bed method.

9. The method according to claim 8, wherein the coated plastic particles are blown into a cavity while heat is supplied, wherein the plastic particles expand further and weld together and, after cooling, cell walls of the abradable coating structure remain.

10. The method according to claim 9, wherein organic substances are removed from the abradable coating structure by means of a thermal treatment.

11. A component in a fluid machine, in particular a turbomachine, a pump, an aircraft engine, a gas turbine, a blade in a turbomachine having at least one abradable coating structure according to claim 1.

12. The component according to claim 1, wherein it is designed as an abradable coating, abradable surface or sealing surface for a labyrinth seal.
